(19) United States
(12) Patent Application Publication
(10) Pub. No.: US 2006/0246783 A1
(43) Pub. Date: Nov. 2, 2006

(54) Electrical connector assembly

(76) Inventor: Yi-Tse Ho, Tainan Hsien (TW)

Correspondence Address: MOLEX INCORPORATED, 2222 WELLINGTON COURT, LISLE, IL, 60532, US

(21) Appl. No.: 11/409,115

(22) Filed: Apr. 21, 2006

(30) Foreign Application Priority Data
Apr. 21, 2005 (TW) 94112705

(51) Int. Cl. H01R 24/04

(52) U.S. Cl. 439/669

(57) ABSTRACT

A plug connector is provided for mating with a receptacle connector which has three mating terminals including a ground terminal, a detect terminal and a power terminal. The plug connector includes an insulative housing having a mating end and a terminating end with a receiving space proximate the mating end and a through hole proximate the terminating end. A first hollow metal sleeve is disposed in the receiving space for engaging a first one of the mating terminals of the receptacle connector. A second hollow metal sleeve is disposed around at least a portion of the insulative housing for engaging a second one of the terminals of the receptacle connector. A conductive terminal has a base portion extending through the through hole in the insulative housing. The conductive terminal has a connecting portion projecting from the base portion at the terminating end of the housing and a contact portion projecting from the base portion into the receiving space for engaging a third one of the terminals of the receptacle connector.

### FIELD OF THE INVENTION

This invention generally relates to the art of electrical connectors and, particularly, to an electrical connector assembly which includes a plug connector and a receptacle connector.

### BACKGROUND OF THE INVENTION

FIGS. 1 and 2 show a prior art electrical connector assembly, generally designated 1, which includes a plug connector, generally designated 2, insertable into a receptacle connector, generally designated 3. The receptacle connector includes an insulative housing 4 having a receptacle 5 for receiving the plug connector. A printed circuit board has three conductive terminals 7, 8 and 9 mounted thereon, as by soldering. Three electrical lead wires 10 are connected to the terminals, also by soldering. Terminal 7 is a power terminal. Terminal 8 is a ground terminal. Terminal 9 is a detect terminal. Insulative housing 4 is mounted to the printed circuit board and surrounds or encases the terminals. A generally U-shaped securing device 11 embraces the housing and is snapped onto the printed circuit board to hold the housing onto the board surrounding the terminals.

Plug connector 2 includes a generally cylindrical insulative housing 12 having a metal sleeve 13 thereabout. A conductive terminal 14 is inserted into the housing and has a connecting end 14a for connection to an electrical wire 16. Terminal 14 has a contact end formed by a pair of contact arms 14b which are spaced apart transversely of an insertion direction “A” of the plug connector into the receptacle connector.

When plug connector 2 is inserted into receptacle 5 of receptacle connector 3 as seen in FIG. 2, metal sleeve 13 will engage ground terminal 8 of the receptacle connector, as the sleeve presses on the inside of the ground terminal. Metal sleeve 30 also engages detect terminal 9 of the receptacle connector and, thereby, detects insertion of the plug connector into the receptacle connector. Terminal 14 is used for transmitting power in the plug connector, and the contact arms 14b of terminal 14 engage power terminal 7 of the receptacle connector for transmitting power through connector assembly 1.

One of the problems with prior art connector assembly 2 is that manufacturers have developed similar plug connectors that are suitable for larger electrical current transmission than most commercially available plug connectors. If a plug connector for transmitting larger electrical currents is inserted into receptacle connector 3 by error, the large currents will damage electronic components electrically connected to the receptacle connector through wires 10. Therefore, different receptacle connectors must be designed for receiving only certain plug connectors to prevent damaging ancillary equipment.

### SUMMARY OF THE INVENTION

An object, therefore, of the invention is to provide a new and improved electrical connector assembly of the character described.

In the exemplary embodiment of the invention, a plug connector is provided for mating with a receptacle connector which has three mating terminals including a ground terminal, a detect terminal and a power terminal. The plug connector includes an insulative housing having a mating end and a terminating end with a receiving space proximate the mating end and a through hole proximate the terminating end. A first hollow metal sleeve is disposed in the receiving space for engaging a first one of the mating terminals of the receptacle connector. A second hollow metal sleeve is disposed around at least a portion of the insulative housing for engaging a second one of the terminals of the receptacle connector. A conductive terminal has a base portion extending through the through hole in the insulative housing. The conductive terminal has a connecting portion projecting from the base portion at the terminating end of the housing and a contact portion projecting from the base portion into the receiving space for engaging a third one of the terminals of the receptacle connector.

According to one aspect of the invention, the insulative housing is a two-part housing with the two parts joined at respective coupling portions and with the through hole extending through the joined coupling portions. The first hollow metal sleeve includes a tube portion disposed in the receiving space and a connecting finger portion extending toward the terminating end of the housing. The insulative housing has positioning projections spaced apart in a direction between the mating and terminating ends of the housing, for positioning the second hollow metal sleeve between the positioning projections.

In the preferred embodiment, the first hollow metal sleeve is provided for engaging the power terminal of the receptacle connector. The second hollow metal sleeve is provided for engaging the ground terminal of the receptacle connector. The conductive terminal is provided for engaging the detect terminal of the receptacle connector.

Other objects, features and advantages of the invention will be apparent from the following detailed description taken in connection with the accompanying drawings.

### BRIEF DESCRIPTION OF THE DRAWINGS

The features of this invention which are believed to be novel are set forth with particularity in the appended claims. The invention, together with its objects and the advantages thereof, may be best understood by reference to the following description taken in conjunction with the accompanying drawings, in which like reference numerals identify like elements in the figures and in which:

FIG. 1 is an exploded perspective view of a prior art electrical connector assembly as described in the Background, above;

FIG. 2 is a perspective view of the prior art connector assembly in assembled and mated condition;

FIG. 3 is a view similar to that of FIG. 2, but of an electrical connector assembly according to the invention;

FIG. 4 is an exploded perspective view of the connector assembly of FIG. 3;

FIG. 5 is an exploded perspective view of the plug connector according to the invention;

FIG. 6 is an exploded perspective view of the two housing parts of the plug connector herein;

FIG. 7 is a perspective view of the main components of the plug connector connected to an electrical cable;

FIG. 8 is a perspective view showing a protective boot molded about the assembly of FIG. 7;

FIG. 9 is an exploded perspective view of the receptacle connector of the invention;

FIG. 10 is a perspective view showing the mating end of the receptacle connector;

FIG. 11 is a vertical section through the insulative housing of the receptacle connector, taken generally along line 11-11 in FIG. 9;

FIG. 12 is a vertical section through the housing taken generally along line 12-12 in FIG. 9;

FIG. 13 is a side elevational view showing the plug connector and the receptacle connector of the invention in mated condition;

FIG. 14 is a horizontal section taken generally along line 14-14 in FIG. 13;

FIG. 15 is an enlarged, rear elevational view looking at the left-hand end of FIG. 13; and

FIG. 16 is a vertical section taken generally along line 16-16 in FIG. 15.

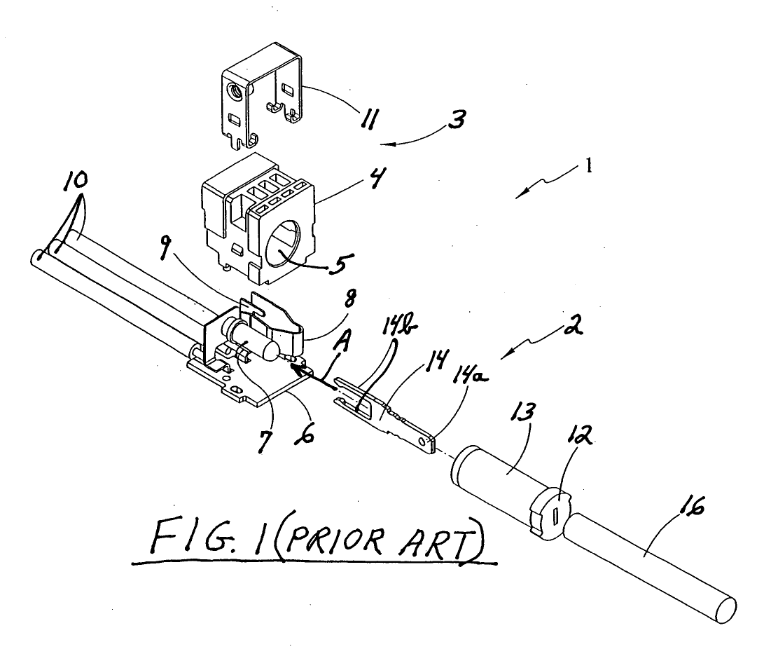

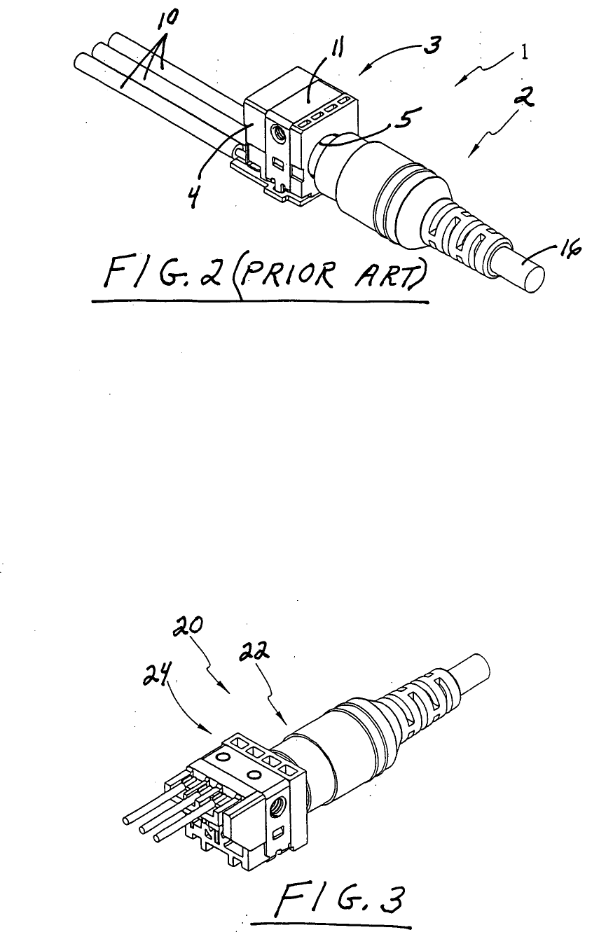

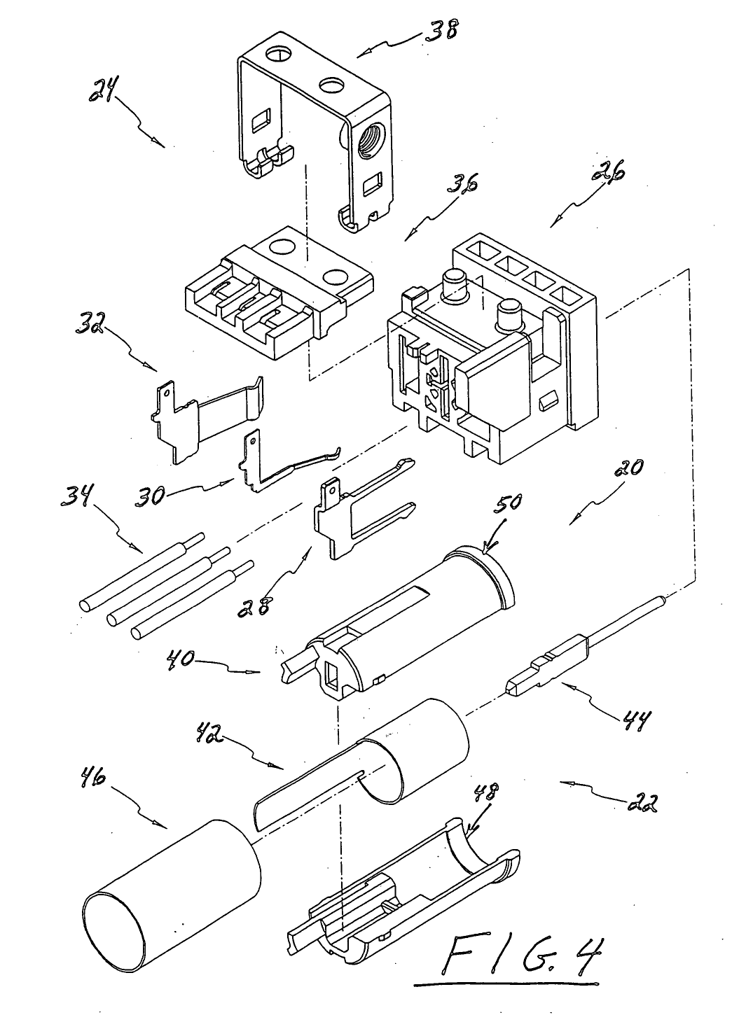

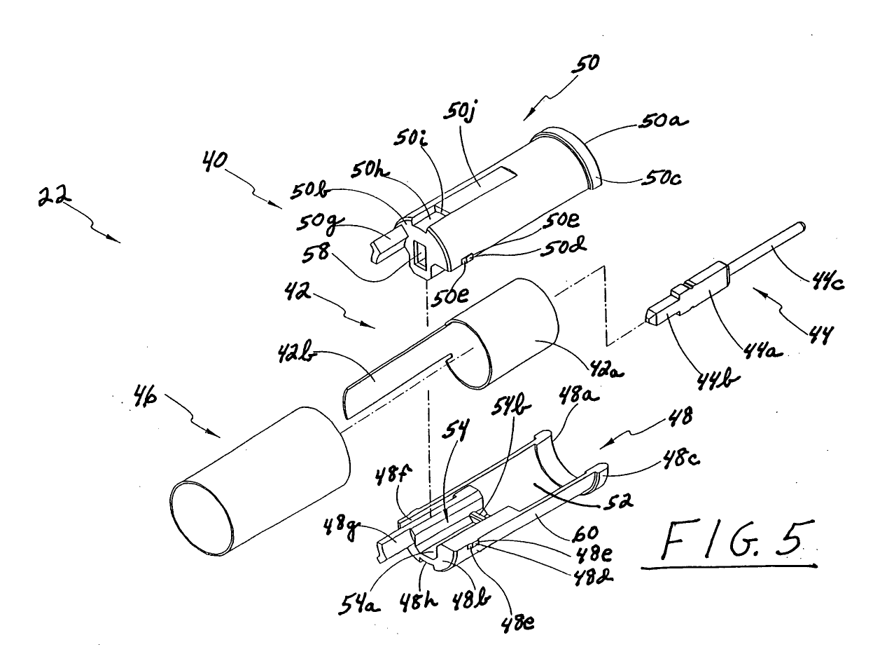

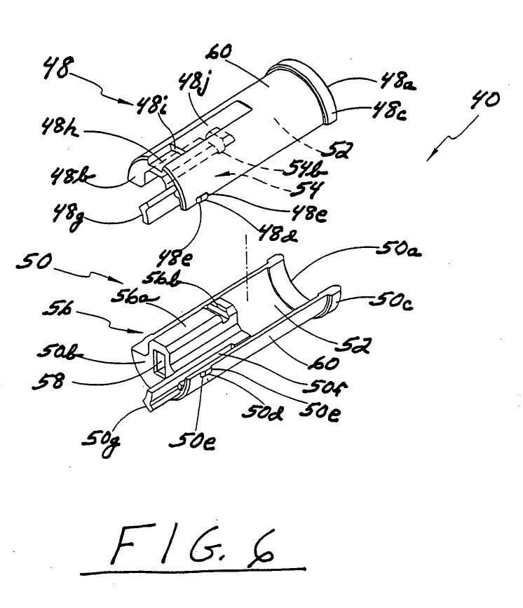

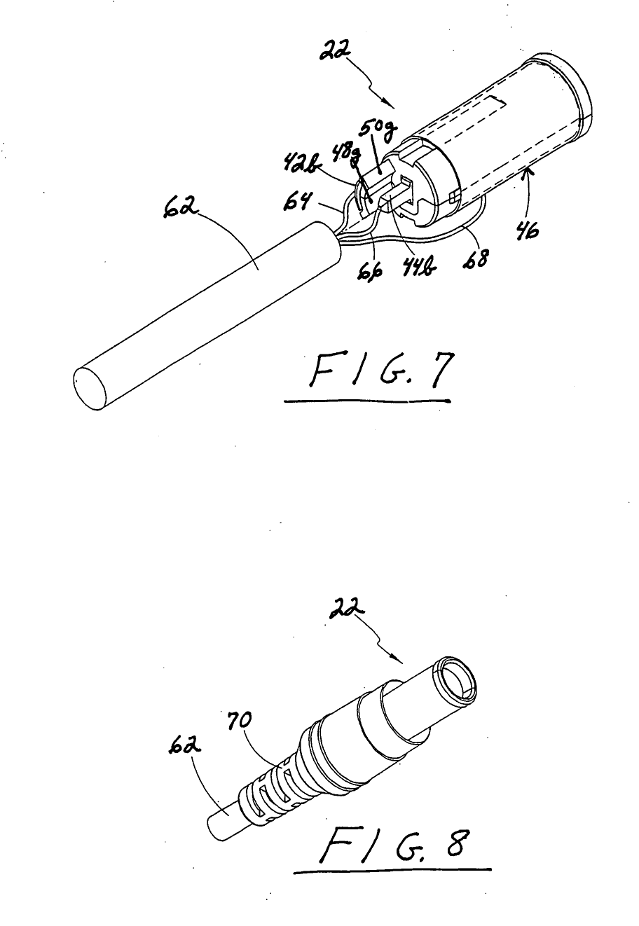

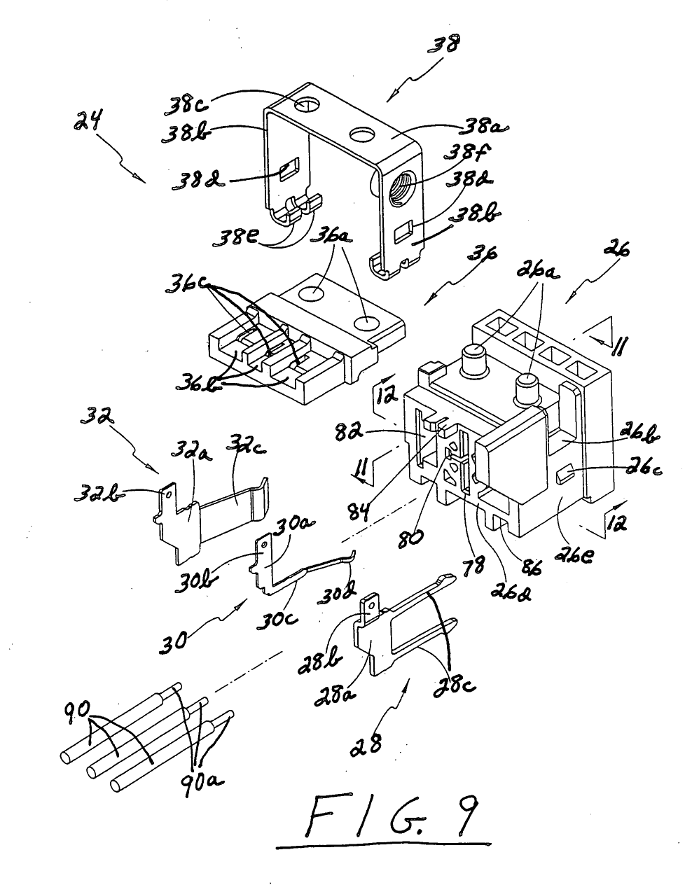

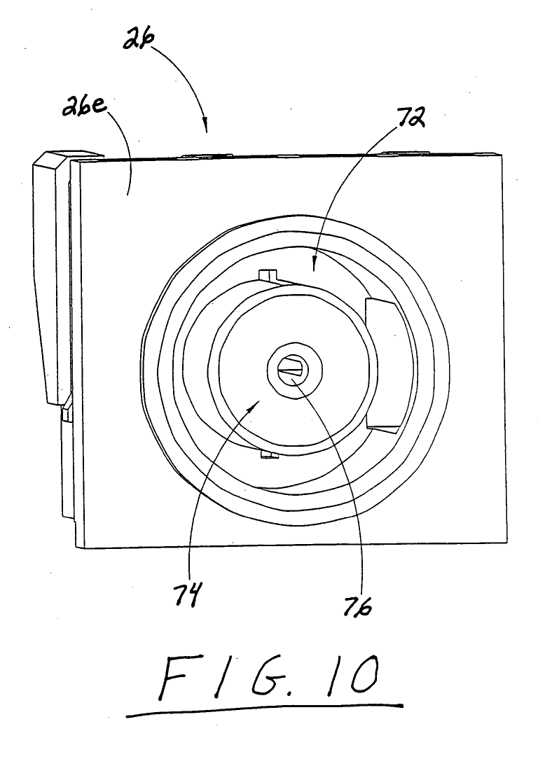

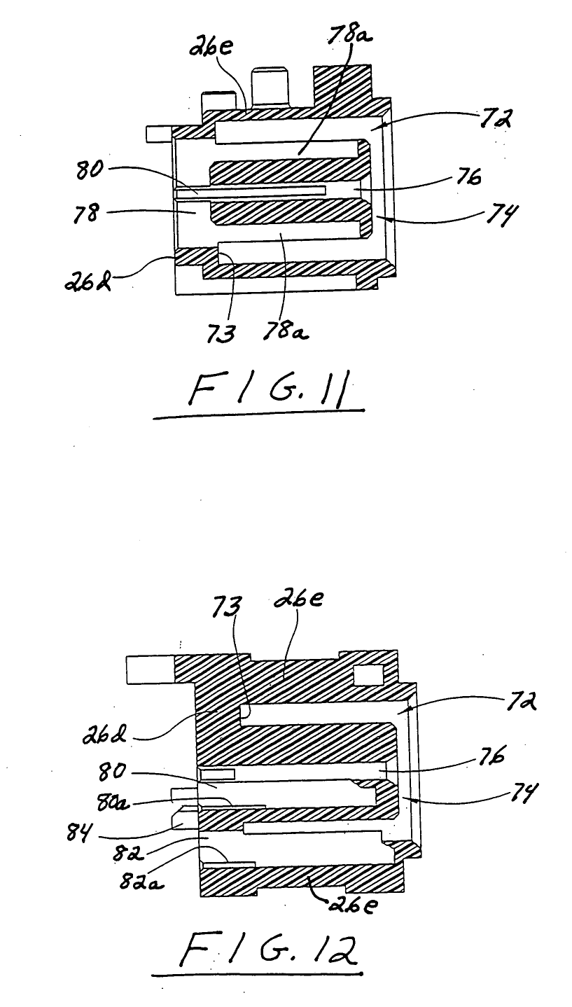

### DETAILED DESCRIPTION OF THE PREFERRED EMBODIMENT

Referring to the drawings in greater detail, and first to FIGS. 3 and 4, the invention is embodied in an electrical connector assembly, generally designated 20, which includes a plug connector, generally designated 22, insertable into a receptacle connector, generally designated 24. The receptacle connector includes an insulative housing, generally designated 26, which mounts three mating terminals including a power terminal, generally designated 28, a detect terminal, generally designated 30, and a ground terminal, generally designated 32. The three terminals are connected to three electrical wires, generally designated 34. The electrical wires are managed by a wire management board, generally designated 36, and housing 26 is held onto the board by a securing device, generally designated 38.

Still referring generally to FIG. 4, plug connector 22 includes a two-part insulative housing, generally designated 40. A first hollow metal sleeve, generally designated 42 is disposed within the housing. A conductive terminal, generally designated 44, also is disposed within the housing. A second hollow metal sleeve, generally designated 46, is disposed around the outside of the housing.

More particularly, FIG. 5 shows details of the components of plug connector 22, and FIG. 6 shows further details of the two-part housing 40 which includes first and second housing parts, generally designated 48 and 50, respectively. Each housing part is a one-piece structure unitarily molded of dielectric material such as plastic or the like. The housing parts are generally semi-cylindrical and, when combined, form a substantially cylindrical insulative housing having an interior receiving space 52. Housing part 48 includes a concave coupling portion, generally designated 54, and housing part 50 includes a convex coupling portion, generally designated 56, with the coupling portions nesting when the two housing parts are joined.

Still referring to FIGS. 5 and 6, housing part 48 of the plug connector includes a front end 48a and a rear end 48b. An outwardly projecting positioning flange 48c is located at the front end, and a pair of positioning bosses 48d are located near the rear end. The positioning bosses have front and rear chamfered surfaces 48e. A narrow slot 48f opens at rear end 48b, and a finger 48g projects rearwardly of the rear end immediately inside the slot. A shallow recess 48h is formed in the outside of housing part 48 and opens at the rear end thereof. A shoulder 48i is formed at the inner end of the groove, and a flat land 48j is formed forwardly of mating the shoulder. Coupling portion 54 of housing part 48 forms an enlarged groove 54a, and a positioning flange 54b is formed at the front end of the groove.

Housing part 50 of the two-part insulative housing 40 of plug connector 22 is somewhat similar to housing part 48. Similarly, housing part 50 includes a front end 50a, a rear end 50b, a positioning flange 50c at the front end and a pair of positioning bosses 50d near the rear end. The front and rear edges of positioning bosses 50d, again, are chamfered, as at 50e. A narrow slot 50f opens at the rear of housing part 50, and a finger 50g projects rearwardly of the housing part alongside the slot. Like housing part 48, housing part 50 has a rearwardly opening recess 50h on the outside of the housing part and which leads to a shoulder 50i and a flat land 50j. Coupling portion 56 of housing part 50 has an enlarged rib 56a which, in turn, is provided with a positioning notch 56b near the front end of the rib. A through hole 58 extends entirely, longitudinally through rib 56a.

When housing parts 48 and 50 are joined, enlarged rib 56a of housing part 50 nests within enlarged groove 54a of housing part 48, while positioning flange 54b seats within positioning notch 56b. The two housing parts form a generally cylindrical receiving space 52 which opens at the front end of the composite insulative housing. Slot 48f of housing part 40 becomes aligned with slot 50f of housing part 50, while fingers 48g and 50g become juxtaposed as seen in FIG. 7. Positioning flanges 48c/50c and positioning bosses 48d/50d combine to form a shallow recessed area 60 therebetween.

Referring to FIG. 5, the first hollow metal sleeve 42, which forms the power terminal of plug connector 22, includes a front cylindrical portion 42a and a rearwardly projecting finger portion 42b. The front cylindrical portion 42a of the power sleeve is disposed within receiving space 52 between the two housing parts. Finger 42e projects rearwardly beyond the rear ends of the housing parts and are protected by fingers 48g and 50g of the two housing parts as seen in FIG. 7. The second hollow metal sleeve 46, which forms the ground terminal of the plug connector, is positioned about the two joined housing parts within recessed area 60. The sleeve holds the two housing parts together. The sleeve is assembled over the joined housing parts from the rear thereof by the chamfered edges 48e/50e of positioning bosses 48d/50d.

Conductive terminal 44 which forms the detect terminal of the plug connector includes a base portion 48a, a connecting portion 44b projecting rearwardly of the base portion, and a contact portion or pin 44c projecting forwardly of the base portion. Terminal 44 is assembled by inserting base portion 44a into through hole 58 in housing part 50 and the base portion is held therein by a press-fit. When the terminal is so mounted, contact portion 44c projects into receiving space 52, and connecting portion 44b projects rearwardly of the housing as seen in FIG. 7.

FIG. 7 shows an electrical cable 62 which has a power electrical wire 64, a detect electrical wire 66 and a ground electrical wire 68. The power electrical wire 64 is connected, as by soldering, to the finger 42b of the first (power) metal sleeve 42. The detect wire 60 is connected, as by soldering, to the rearwardly connecting portion 44b of detect terminal 44. The ground electrical wire 68 is connected, as by soldering, to the second (ground) hollow metal sleeve 46. After all three connections are made, an elastomeric strain relief boot 70 is molded about the connecting area, about the rear of the housing of the plug connector and about electrical cable 62, as can be seen in FIG. 8.

Referring to FIGS. 9-12, housing 26 of receptacle connector 24 is a one-piece structure unitarily molded of dielectric material such as plastic or the like. As seen best in FIG. 9, the housing has a pair of positioning posts 26a projecting upwardly therefrom, a recess 26b at one side thereof, and a pair of chamfered latch bosses 26c at opposite sides thereof. The housing has a rear wall 26d and a surrounding wall 26e which extends forwardly from the rear wall and defines a receptacle, generally designated 72 (FIGS. 11 and 12) for receiving plug connector 22. The bottom of the receptacle defines a stop wall 73. An elongated post, generally designated 74, extends forwardly from rear wall 26d into receptacle 72. The post has a through hole 76 extending longitudinally therethrough.

As best seen in FIG. 9, first, second and third terminal-receiving grooves 78, 80 and 82, respectively, are formed in rear wall 26d of housing 26. A slotted boss 84 projects rearwardly of the rear wall at the top thereof. A channel 86 is formed at the bottom of the housing below the rear wall.

FIG. 11 shows that the terminal-receiving slot 78 has a pair of slot portions 78a on opposite sides of post 74, with the slot portions communicating with receptacle 72 at opposite sides of the post. FIG. 12 shows that the terminal-receiving slot 80 extends into post 74 and communicates with the through hole 76 which extends longitudinally through the post. Slot 80 has a narrow retaining groove 80a at one side thereof. FIG. 12 also shows that the terminal-receiving slot 82 extends forwardly into the surrounding wall 26e of the housing and communicates with one side of receptacle 72. Slot 82 has a narrow retaining groove 82a at one side thereof.

Referring back to FIG. 9, power terminal 28 includes a body portion 28a, a connecting portion 28b and a pair of contact arms 28c which project forwardly of the body portion. Detect terminal 30 includes a body portion 30a, a connecting portion 30b and a contact arm 30c projecting forwardly of the body portion and terminating in a flexible distal end 30d. Ground terminal 32 includes a body portion 32a, a connecting portion 32b and a contact arm 32c projecting forwardly of the body portion.

Referring to FIGS. 11 and 12 in conjunction with FIG. 9, when power terminal 28 is inserted into its terminal-receiving slot 78, contact arms 28c of the terminal move into slot portions 78a (FIG. 11) whereby the contact arms are exposed within receptacle 72 at opposite sides of post 74. When detect terminal 30 is inserted into its respective terminal-receiving slot 80, contact arm 30c moves into the slot and the flexible distal end 30d is exposed or projects slightly into through hole 76 in post 72. The edge of the body of the detect terminal is retained in the retaining groove 80a by an interference fit. When ground terminal 32 is inserted into its terminal-receiving slot 82, contact arm 32c of the terminal is exposed at one side of receptacle 72 as described above in relation to FIG. 12. The bottom edge of the ground terminal is held within retaining groove 82a by an interference fit.

Returning again back to FIG. 9, the wire management board 32 is mounted on housing 26 by means of positioning posts 26a on the housing projecting through a pair of through holes 36a in the board. Three channels 36b are formed in the top, rear of the board, and three through slots 36c extend through the board and communicate with the channels. Three electrical wires 90 are shown with exposed conductors 90a. The three wires are positioned into channels 36b. When the wire management board is mounted to the top of housing 26a, connecting portions 28b, 30b and 32b of terminals 28, 30 and 32, respectively, project upwardly through slots 36c in the wire management board, and the conductors 90a of the electrical wires are soldered to the connecting portions of the terminals.

The wire management board 36 is secured to the top of housing 26 by securing device 38 which may be fabricated of spring metal material. The securing device is generally U-shaped and includes a top wall 38a and a pair of side walls 38b. The top walls have through holes 38c which fit over the top of positioning posts 26a of housing 26 after the posts have been inserted through holes 36a of the wire management board. The securing device is pushed downwardly onto the housing, with holes 38c aligned with positioning posts 26a, and until a pair of latch openings 38d in the side walls of the securing device snap into latching engagement over the chamfered latch bosses 26c of the housing. A plurality of hooks 38e are bent inwardly at the bottom distal ends of side walls 38b of the securing device, and the hooks snap into position beneath the bottom of the housing. Finally, an inwardly threaded through hole 38f is formed in one of the side walls for receiving a set screw (not shown). The set screw is threaded into the internally threaded hole and into recess 26b and is screwed into a force fit against the bottom wall of the recess to securely lock the securing device in place and, in turn, lock the wire management board 36 to the top of the housing.

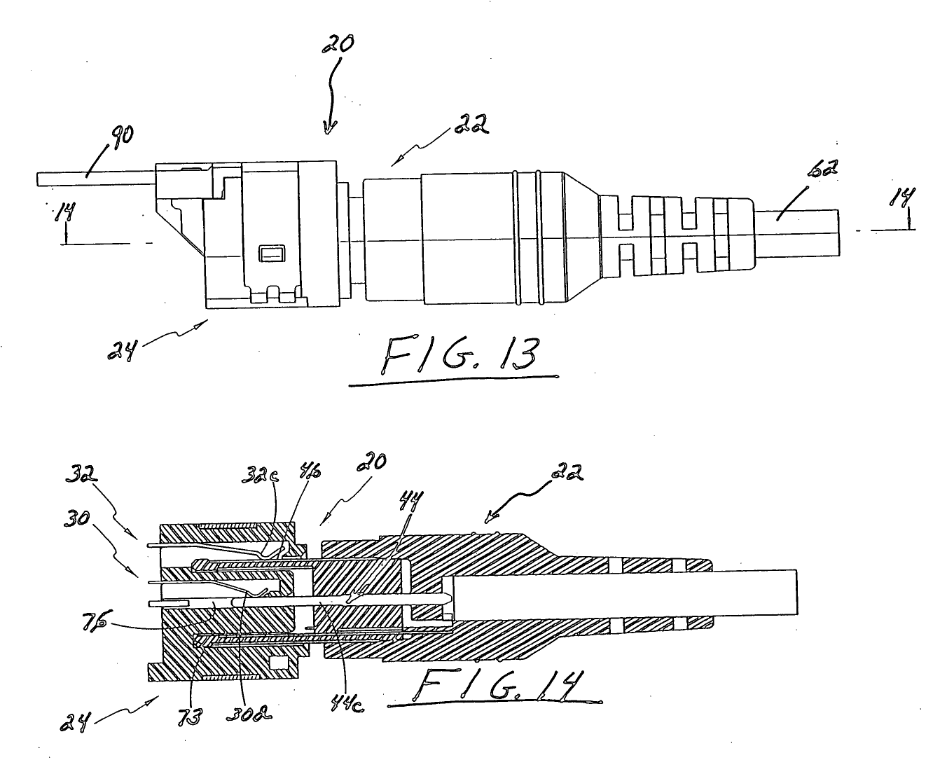

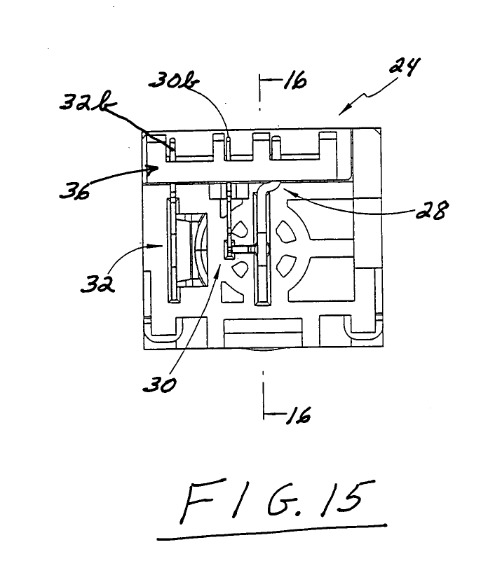

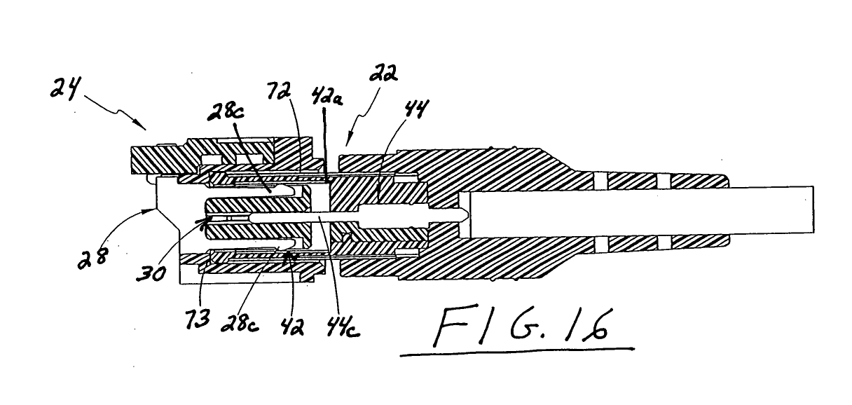

FIGS. 13-16 show plug connector 22 fully mated with receptacle connector 24. When fully inserted, the plug connector abuts against the bottom stop wall 73 of the receptacle. It can be seen in FIG. 16 that the contact arms 28c of power terminal 28 of the receptacle connector are in engagement with opposite inside surfaces of the front cylindrical portion 42a of the first hollow metal sleeve 42 which forms the power terminal of the plug connector. It can be seen in both FIGS. 14 and 16 that the contact or pin portion 44c of detect terminal 44 extends into through hole 76 and into engagement with contact arm 30d of detect terminal 30 of the receptacle connector. It can be seen in FIG. 14 that the contact arm 32c of ground terminal 32 of the receptacle connector is in engagement with the outside surface of the second hollow metal sleeve 46 which forms the ground terminal of the plug connector.

It will be understood that the invention may be embodied in other specific forms without departing from the spirit or central characteristics thereof. The present examples and embodiments, therefore, are to be considered in all respects as illustrative and not restrictive, and the invention is not to be limited to the details given herein.

What is claimed is:

1. A plug connector for mating with a receptacle connector which has three mating terminals including a ground terminal, a detect terminal and a power terminal, the plug connector comprising:
an insulative housing including a mating end and a terminating end with a receiving space proximate the mating end and a through hole proximate the terminating end;
a first hollow metal sleeve disposed in the receiving space for engaging a first one of the mating terminals of the receptacle connector;
a second hollow metal sleeve disposed around at least a portion of the insulative housing for engaging a second one of the terminals of the receptacle connector; and
a conductive terminal having a base portion extending through the through hole in the insulative housing, a connecting portion projecting from the base portion at the terminating end of the housing, and a contact portion projecting from the base portion into the receiving space of the housing for engaging a third one of the terminals of the receptacle connector.

2. The plug connector of claim 1 wherein said insulative housing comprises a two-part housing with the two parts joined at respective coupling portions and with the through hole extending through the joined coupling portions.

3. The plug connector of claim 1 wherein said first hollow metal sleeve includes a tube portion disposed in the receiving space and a connecting finger portion extending toward the terminating end of the housing.

4. The plug connector of claim 1 wherein said insulative housing has positioning projections spaced apart in a direction between the mating and terminating ends of the housing for positioning the second hollow metal sleeve between the positioning projections.

5. The plug connector of claim 1 wherein said first hollow metal sleeve is provided for engaging the power terminal of the receptacle connector.

6. The plug connector of claim 5 wherein said second hollow metal sleeve is provided for engaging the ground terminal of the receptacle connector.

7. The plug connector of claim 5 wherein said conductive terminal is provided for engaging the detect terminal of the receptacle connector.

8. A receptacle connector for mating with a plug connector which has three mating terminals including a ground terminal, a detect terminal and a power terminal, the receptacle connector comprising:
an insulative housing including a rear wall and a surrounding wall extending forwardly from the rear wall and defining a receptacle for receiving the plug connector, and an elongated post extending forwardly from the rear wall into the receptacle, the post having a through hole longitudinally through the post;
first and second conductive terminals mounted on the housing and having respective contact arms extending into said receptacle for engaging two of the mating terminals of the plug connector; and
a third conductive terminal mounted on the housing and having a contact arm extending forwardly into the through hole in said post for engaging the remaining one of the mating terminals of the plug connector.

9. The receptacle connector of claim 8 wherein said first and second conductive terminals include body portions mounted in the rear wall of the housing on opposite sides of the post whereby the contact arms of the first and second conductive terminals extend forwardly into the receptacle at opposite sides of the post.

10. The receptacle connector of claim 8 wherein said third conductive terminal includes a body portion mounted in the rear wall of the housing with the contact arm of the third conductive terminal extending forwardly into the through hole in said post.

11. The receptacle connector of claim 10 wherein said first and second conductive terminals include body portions mounted in the rear wall of the housing on opposite sides of the post whereby the contact arms of the first and second conductive terminals extend forwardly into the receptacle at opposite sides of the post.

12. The receptacle connector of claim 8, including a wire management board mountable on the insulative housing for properly positioning three electrical wires for connection to the three conductive terminals.

13. The receptacle connector of claim 12 wherein said first, second and third conductive terminals having connecting portions for connection to said three electrical wires.

14. The receptacle connector of claim 13 wherein said wire management board has three wire-receiving grooves aligned with the connecting portions of the terminals when the board is mounted on the insulative housing.

15. The receptacle connector of claim 12, further including a securing device for holding the wire management board on the insulative housing.

16. The receptacle connector of claim 15 wherein said wire management board is fabricated of dielectric plastic material, and said securing device is fabricated of spring metal material embracing the housing and snap-latched into securing engagement with the board.

17. An electrical connector assembly, comprising:
a receptacle connector including an insulative housing having a rear wall and a surrounding wall extending forwardly from the rear wall and defining a receptacle for receiving the plug connector, and an elongated post extending forwardly from the rear wall into the receptacle, the post having a through hole longitudinally through the post,
first and second conductive terminals mounted on the housing and having respective contact arms extending into said receptacle, and
a third conductive terminal mounted on the housing and having a contact arm extending forwardly into the through hole in said post; and
a plug connector including an insulative housing having a mating end and a terminating end with a receiving space proximate the mating end and a through hole proximate the terminating end whereby the mating end is insertable into the receptacle of the insulative housing of the receptacle connector and the elongated post of the receptacle connector is insertable into said receiving space,
a first hollow metal sleeve disposed in the receiving space for engaging a first one of the first and second conductive terminals of the receptacle connector,
a second hollow metal sleeve disposed around at least a portion of the insulative housing of the plug connector for engaging a second one of said first and second conductive terminals of the receptacle connector, and
a conductive terminal having a contact portion insertable into the through hole in the post of the insulative housing of the receptacle connector and into engagement with the third conductive terminal of the receptacle connector.

18. The electrical connector assembly of claim 17 wherein said insulative housing of the plug connector comprises a two-part housing with the two parts joined at respective coupling portions and with the through hole in the housing extending through the joined coupling portions.

19. The electrical connector assembly of claim 17 wherein said first hollow metal sleeve includes a tube portion disposed in the receiving space and a connecting finger portion extending toward the terminating end of the housing of the plug connector.

20. The electrical connector assembly of claim 17 wherein said first hollow metal sleeve of the plug connector and the first conductive terminal of the receptacle connector are power terminals.

21. The electrical connector assembly of claim 20 wherein said second hollow metal sleeve of the plug connector and the second conductive terminal of the receptacle connector are ground terminals.

22. The electrical connector assembly of claim 20 wherein said conductive terminal of the plug connector and the third conductive terminal of the receptacle connector are detect terminals.

23. The electrical connector assembly of claim 17, including a wire management board mountable on the insulative housing of the receptacle connector for properly positioning three electrical wires for connection to the three conductive terminals of the receptacle connector.

24. The electrical connector assembly of claim 23, further including a securing device for holding the wire management board on the insulative housing of the receptacle connector.

25. The electrical connector assembly of claim 24 wherein said wire management board is fabricated of dielectric plastic material, and said securing device is fabricated of spring metal material embracing the housing and snap-latched into securing engagement with the board.
